(19) United States
(12) Patent Application Publication
(10) Pub. No.: US 2025/0358727 A1
(43) Pub. Date: Nov. 20, 2025

(54) METHOD AND APPARATUS FOR SERVICE NEGOTIATION IN PERSONAL IOT NETWORK

(71) Applicant: Samsung Electronics Co., Ltd., Suwon-si, Gyeonggi-do (KR)

(72) Inventors: Sidhant JAIN, Bangalore (IN); Kailash Kumar JHA, Bangalore (IN); Lalith KUMAR, Bangalore (IN); Anoop P V, Bangalore (IN)

(21) Appl. No.: 18/862,748

(22) PCT Filed: May 4, 2023
(86) PCT No.: PCT/KR2023/006179

§ 371 Date: Nov. 4, 2024

(30) Foreign Application Priority Data
May 5, 2022 (IN) 202241026252
Apr. 11, 2023 (IN) 2022 41026252

(51) Int. Cl. H04W 48/18; H04L 67/30; H04W 12/08; H04W 84/18

(52) U.S. Cl. CPC H04W 48/18; H04L 67/30; H04W 12/08; H04W 84/18

(57) ABSTRACT

The disclosure relates to a 5G or 6G communication system for supporting a higher data transmission rate. Embodiments herein provide method for service negotiation in a PIN (1000) by first PINE (300a). The method includes receiving a service from a second PINE (300b) in the PIN. Further, the method includes receiving a PIN profile from PIN network apparatus (400). The PIN profile includes a list of PINE available in the PIN and the service offered by the list of PINE available in the PIN. Further, the method includes determining whether service from the second PINE is available in the PIN based on the list of PINE available in the PIN and the service offered by the list of PINE available in the PIN. In an embodiment, the method includes remaining in the PIN and receiving the service in the PIN when the service is available in the PIN. Alternately, the method includes leaving PIN when service or the second PINE is not available in the PIN.

### TECHNICAL FIELD

The present disclosure relates to wireless communication system. More specifically, the present disclosure relates to service negotiation in personal IoT network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance service negotiation in personal IoT network.

### Solution to Problem

Accordingly, the embodiment herein is to provide a method for service negotiation in a PIN. The method includes receiving, by a first PINE, a service from a second PINE in the PIN. The first PINE and the second PINE are registered with a PIN network apparatus in the PIN. Further, the method includes receiving, by the first PINE, a PIN information also called as PIN profile from the PIN network apparatus. The PIN profile includes a list of PINE available in the PIN and a service offered by the list of PINE available in the PIN. Further, the method includes determining, by the first PINE, whether the service from the second PINE is available in the PIN based on the list of PINE available in the PIN and the service offered by the list of PINE available in the PIN. In an embodiment, the method includes remaining in the PIN and receiving the service in the PIN when the service is available in the PIN. In another embodiment, the method includes leaving the PIN when the service or the second PINE is not available in the PIN.

In an embodiment, the PIN network apparatus is at least one of a PIN server, a PEGC, and a PEMC.

Accordingly, the embodiment herein is to provide a method for service negotiation in a PIN. The method includes detecting, by a PIN network apparatus, an event in the PIN. Further, the method includes updating, by the PIN network apparatus, a PIN profile including a list of PINE available in the PIN and a service offered by the list of PINE available in the PIN based on the detected event. Further, the method includes sending, by the PIN network apparatus, the PIN profile to a PINE in the PIN.

In an embodiment, the event includes at least one of a new PINE joined the PIN and a service offered by the newly joined PINE in the PIN, the PINE removed by the PIN network apparatus in the PIN, the PINE leaving the PIN, a change in capability of the PINE in the PIN, and a change in the service of the PINE in the PIN.

In an embodiment, sending, by the PIN network apparatus, the PIN profile to the PINE in the PIN includes broadcasting the PIN profile to all PINE in the PIN or sending the PIN profile to the PINE that uses the service in the PIN.

In an embodiment, the method includes receiving, by the PIN network apparatus, a request message to join the PIN from the PINE. The request message includes security credentials of the PINE, a UE identifier, and a service offered by the PINE. Further, the method includes verifying, by the PIN network apparatus, whether the PINE is authorized to join the PIN. Further, the method includes joining, by the PIN network apparatus, the PINE to the PIN upon successful verification. Further, the method includes updating, by the PIN network apparatus, the PIN profile with information of the PINE and the service offered by the newly joined PINE in the PIN.

In an embodiment, the method includes receiving, by the PIN network apparatus, a request message to leave the PIN from the PINE. The request message includes the security credentials of the PINE, a UE identifier, and the service offered by the PINE. Further, the method includes verifying, by the PIN network apparatus, whether the PINE is authorized. Further, the method includes removing, by the PIN network apparatus, the PINE from the PIN and disabling access of the PINE to a 5GS in the PIN based on the request. Further, the method includes updating, by the PIN network apparatus, the PIN profile with information of the PINE that requested to leave the PIN.

In an embodiment, the method includes determining, by the PIN network apparatus, to remove the PINE from the PIN. Further, the method includes sending, by the PIN network apparatus, a notification about removal to the PINE. Further, the method includes removing, by the PIN network apparatus, the PINE from the PIN and disabling access of the PINE to the 5GS in the PIN. Further, the method includes updating, by the PIN network apparatus, the PIN profile with information of the PINE removed from the PIN.

Accordingly, the embodiment herein is to provide a PINE for service negotiation in a PIN. The PINE includes a service negotiation controller coupled to a memory and a processor. The service negotiation controller is configured to receive a service from a second PINE in the PIN. The first PINE and the second PINE are registered with a PIN network apparatus in the PIN. Further, the service negotiation controller receives a PIN profile from the PIN network apparatus. The PIN profile includes a list of PINE available in the PIN and the service offered by the list of PINE available in the PIN. Further, the service negotiation controller determine whether the service from the second PINE is available in the PIN based on the list of PINE available in the PIN and the service offered by the list of PINE available in the PIN. In an embodiment, the service negotiation controller remains in the PIN and receiving the service in the PIN when the service is available in the PIN. In another embodiment, the service negotiation controller leaves the PIN when the service or the second PINE is not available in the PIN.

Accordingly, the embodiment herein is to provide a PIN network apparatus for service negotiation in a PIN. The PIN network apparatus includes a Service negotiation controller coupled to a memory and a processor. The Service negotiation controller is configured to detect an event in the PIN. Further, the service negotiation controller is configured to update a PIN profile including a list of PINE available in the PIN and a service offered by the list of PINE available in the PIN based on the detected event. The Service negotiation controller is configured to send the PIN profile to a PINE in the PIN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

According to various embodiments of the disclosure, service negotiation in personal IoT network can be efficiently enhanced.

### BRIEF DESCRIPTION OF DRAWINGS

The method, the PIN network apparatus and the PINE are illustrated in the accompanying drawings, throughout which like reference letters indicate corresponding parts in the various figures. The embodiments herein will be better understood from the following description with reference to the drawings, in which:

FIG. 1 is a flow diagram illustrating a scenario of dynamic service negotiation in a PIN, according to the prior arts;

FIG. 2 is a flow diagram illustrating a scenario of dynamic service negotiation in the PIN, according to the embodiments as disclosed herein;

FIG. 3 shows various hardware components of a PINE, according to the embodiments as disclosed herein;

FIG. 4 shows various hardware components of a PIN network apparatus, according to the embodiments as disclosed herein;

FIG. 5 is a flow chart illustrating a method, implemented by the PINE, for service negotiation in the PIN, according to the embodiments as disclosed herein; and

FIG. 6 is a flow chart illustrating a method, implemented by the PIN network apparatus, for the service negotiation in the PIN, according to the embodiments as disclosed herein.

FIG. 7 illustrates a block diagram of a terminal (or a user equipment), according to embodiments of the present disclosure.

FIG. 8 illustrates a block diagram of a base station, according to embodiments of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

The principal object of the embodiments herein is to provide a method and a system for dynamic service negotiation in a PIN. The PINE informs supported services when the PINE joins the PIN. The list of available services in the PIN is stored in the PEMC/the PEGC/a PIN Network Function (PINNF)/a PIN Application Function (PINAF). The PEMC informs/broadcasts available services to all PINEs in the PIN. Remaining PINE takes appropriate action based on the indication of the PEMC like join/leave the respective PIN. Thus, results in providing the dynamic service negotiation and improving a service quality.

Another object of the embodiments herein is to provide updating a list of PINEs and services offered by a network apparatus when a PINE joins the PIN or a PINE leaves/exits the PIN or a PINE is removed from the PIN by the network apparatus.

Another object of the embodiments herein is to announce or inform the other PINEs part of the PIN that there is change in offered services in the PIN when there is any change (addition or removal) in services offered within the PIN. Based on the indication the PINE decides to remain/join/leave the PIN.

In general, a Personal IoT Element (PINE) joins a PIN (or multiple PINs) to provide specific services to other PINEs or to receive specific services from other Personal IoT Element (PINE)/PIN Element with Gateway Capability (PEGC)/PIN Element with Management Capability (PEMC)/5GS. The service providing PINEs (or service receiving PINEs) can leave the PIN or get disconnected/removed from the PIN at any time. In such a scenario, the PINE providing to (or receiving service from) the removed/disconnected/left PINE may not be required to remain in the PIN, and the PINE may decide to leave the PIN itself.

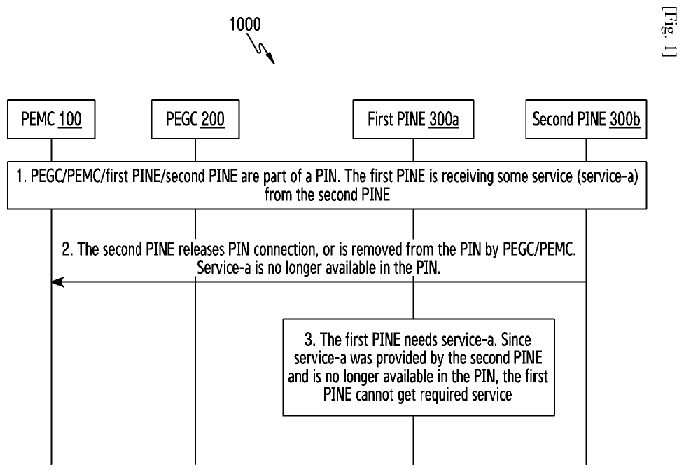

FIG. 1 is a flow diagram illustrating a scenario of dynamic service negotiation in the PIN (1000), according to the prior arts. The PINEs (300a and 300b)/PEGC (200)/PEMC (100) are part of the PIN (1000) and registered with a 5GS. Some PINE (for e.g. first PINE (300a) or PINE (300a)) is receiving service(s) from other PINE (e.g. second PINE (300b) or PINE (300b)) in the PIN (1000). The services may be mandatory and optional for the PINE. Mandatory services are those which are needed by the PINE to remain joined in the PIN (1000) and in absence of those services the PINE cannot remain in the PIN (1000). Optional services are those which may or may not be present for the PINE to remain in the PIN. For example, a printer may be a mandatory service for the PINE, but a colour printer can be optional service for the PINE.

At step 1, the PEGC (200)/the PEMC (100)/the first PINE (300a)/the second PINE (300b) are part of the PIN (1000). The first PINE (300) is receiving some service (i.e., service-a) from the second PINE (300b). At step 2, the second PINE (300b) releases the PIN connection, or is removed from the PIN (1000) by the PEGC (200)/the PEMC (100). That is, the service-a is no longer available in the PIN (1000). At step 3, the first PINE (300a) needs the service-a. Since the service-a is provided by the second PINE (300b) and is no longer available in the PIN (1000), the first PINE (300a) cannot get the required service. Thus, results in reducing the service quality.

It is desired to address the above mentioned disadvantages or other short comings or at least provide a useful alternative.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiment herein is to provide a method for service negotiation in a PIN. The method includes receiving, by a first PINE, a service from a second PINE in the PIN. The first PINE and the second PINE are registered with a PIN network apparatus in the PIN. Further, the method includes receiving, by the first PINE, a PIN profile from the PIN network apparatus. The PIN profile includes a list of PINE available in the PIN and a service offered by the list of PINE available in the PIN. Further, the method includes determining, by the first PINE, whether the service from the second PINE is available in the PIN based on the list of PINE available in the PIN and the service offered by the list of PINE available in the PIN. In an embodiment, the method includes remaining in the PIN and receiving the service in the PIN when the service is available in the PIN. In another embodiment, the method includes leaving the PIN when the service or the second PINE is not available in the PIN.

The proposed method provides a scenario of how the PINEs can maintain list of services/PINEs available in the PIN and may decide to remain in a PIN or leave the PIN according to services available in the PIN.

In an embodiment, when the PINE joins the PIN and the PINE is added to the PIN by the PEGC/the PEMC/a PINNF/a PINAF/a user, a list of PINEs and services offered is updated at the PEGC/the PEMC/the PINNF/PINAF.

In an embodiment, when the PINE leaves/exits the PIN or the PINE is removed from the PIN by the PEGC/the PEMC/PINNF/the PINAF/the user, the list of PINEs and services offered is updated at the PEGC/the PEMC/the PINNF/the PINAF.

In an embodiment, if there is any change (addition or removal) in services offered within the PIN as a result of adding operation or the leaving operation, the PEMC/PEGC/PINNF/PINAF announces or informs the other PINEs part of the PIN that there is change in offered services in the PIN (i.e. it needs to indicate added service, deleted service or exhaustive list of services offered right now). Based on the indication, the PINE decides to remain/join/leave the PIN. Thus, results in providing the dynamic service negotiation and improving a service quality.

Below abbreviations are used in the description in the patent disclosure:
a) 3GPP—3rd Generation Participation Project,
b) 5GC—5G Core Network,
c) D2D—Device to Device,
d) PEGC—PIN Element with Gateway Capability,
e) PEMC—PIN Element with Management Capability,
f) PIN—Personal IoT Network,
g) PINE—PIN Element,
h) ProSe—Proximity Services,
i) UE—User Equipment, and
j) PINMF—PIN Management Function, PINMF and PEMC are used interchangeably and mean the same in this embodiment.

Below terms are used in the description in the patent disclosure:
a. PIN (Personal IoT Network): The PINs provide local connectivity between UEs and/or non-3GPP devices. A Personal IoT Network (PIN) consists of PIN Elements (PINE) that communicate using PIN Direct Connection or direct network connection and is managed locally (using a PIN Element with Management Capability).
b. PINEs: The PINE are UEs and/or non-3GPP devices which form part of the PIN.
c. PEMC: The PINE has the capability to provide means for an authorised administrator to configure and manage a PIN.
d. PEGC: The PINE with Gateway capability provide means to PIN elements to register and access 5G network services. The PEGC can also help in communication between 2 PIN elements that are not within the range to use direct communication.
e. ProSe: ProSe (Proximity Services) is a D2D (Device-to-Device) technology that allows LTE devices to detect each other and to communicate directly.
f. PIN-ID: Unique identifier which identifies the PIN.
g. PINNF (PIN Network Function): The PIN Network function is a 5GC NF responsible for the creation and management of the PIN.
h. PINAF (PIN Application Function): The PIN Application function is a Network Function connected to 5G Core network via NEF (Network Exposure Function). The PINAF is responsible for policy configuration and provisioning of PIN and its elements in the 5GC and PEGC/PEMC/PINE.

Referring now to the drawings and more particularly to FIGS. 2 through 6, where similar reference characters denote corresponding features consistently throughout the figures, there are shown preferred embodiments.

FIG. 2 is a flow diagram illustrating a scenario of dynamic service negotiation in PIN (1000), according to the embodiments as disclosed herein. Below are the steps of dynamic service negotiation:
1. At step 1, the PINEs (300a and 300b)/the PEGC (200)/the PEMC (100) are part of the PIN (1000) and registered with a 5GS and the first PINE (300a) is receiving some service (i.e., service-a) from the second PINE (300b).
2. At step 2, the second PINE (300b) releases a PIN connection, or is removed from the PIN (1000) by the PEGC (200)/the PEMC (100).
3. At step 3, the PEMC (100)/the PEGC (200) broadcasts updated list of available services. Alternatively, the PEMC (100)/the PEGC (200) informs all PINEs using the second PINE services that the second PINE (300b) not being available anymore.
4. At step 4, the first PINE (300a) determines that the mandatory services needs to be in the PIN (1000). When the mandatory service(s) is (are) available in the PIN (1000) then, the PINE (300a) stays in the PIN (1000). When the mandatory service(s) is (are) available in the PIN (1000) then, the PINE (300a) releases itself from the PIN (1000).
5. At step 5, when mandatory services are not available in the PIN (1000), the first PINE (300a) releases itself from the PIN (1000).

In an embodiment, the service is mandatory service or the optional service is indicated to the PEGC (200)/the PEMC (100) by a 5GC/an user/the PINNF/the PIN-AF. The PINNF may get to know about the information from the PIN-AF or the user. User here is also called as upper layers. That is, the user here may be the authorised user/administrator of the PIN, or it may be an application/operating system running on an equipment (e.g., server, a UE or the like).

When the PINE (e.g. the second PINE (300b)) exits or joins the PIN (1000) or is removed/added from/to the PIN (1000) by the PEGC (200)/the PEMC (100)/the PINNF/the PINAF/the user, the list of PINEs and services offered is updated at the PEGC (200)/the PEMC (100)/the PINNF/the AF due to at least one of the below triggers:
A. PIN_Join (or any signal or message) can be initiated by the PINE (e.g. first PINE (300a)) or by the PINNF/the PEMC (100)/the PINAF/the user to indicate the request to join the PIN (and the services it offers e.g. Service-A) and after the PINE has successfully joined the PIN (1000) or the PINE is removed (and the services it offers are also lost).
B. A PINE is removed from the PIN (1000) by the PEMC (100)/the PEGC (200)/the PINNF/the PINAF/the user, or the PINE requests to be released from the PIN (1000), thus a particular service (provided by the removed PINE e.g. service-a) is stopped to be offered by the PIN.
C. PIN_Join (it is any signal or message) can be re-initiated when a member PINE updates it's services in the PIN (1000), i.e. a service is added or removed. In an example, the PINE which offers both printer and colour printer services stops to offer colour printer service but continues to offer printer service. The PIN_Join request in such a case will have the list of services offered currently (printer service) by the PINE or it indicates the deleted service which it has seased to offer or the newly added service which PINE is offering.

When there is any change (addition or removal) in services offered within the PIN (1000) as a result of above operation, the PEMC (100)/the PEGC (200)/the PINNF/the PINAF announces or informs the other PINEs part of the PIN (1000) that there is change in offered services in the PIN (1000). That is, it needs to indicate added service, deleted service or exhaustive list of services offered right now. Different mechanism for this can be:
A. A mapping is maintained at the PEMC (100)/the PEGC (200)/the PINNF/the PINAF which stores the details of services being used by different PINEs. The mapping is in the form service-a: first PINE (300a). In an example, the first PINE (300a) which means service-a is being used by the first PINE (300a). Service-a is offered by some other PINE (i.e., the second PINE (300b)). For the PEMC (100)/the PINNF/the PINAF/the user remembers which PINE is stored with that mapping (e.g. Service-a: first PINE (300a)). When a service is no longer available (due to PINE being removed or service not offered by serving PINE anymore), the PINEs associated with that the service are informed about its deletion. The respective mapping stored at the PEMC (100)/the PINNF/the PINAF is deleted as well.
B. It can use announcement mechanism to indicate the particular PINE/service is released. The PEMC (100)/the PEGC (200) broadcasts the updated list of available service to all PINEs of the PIN (1000). All PINE which are part of PIN will be able to listen to updated list of services available. The announcement can indicate deleted service, added service or exhaustive list of services offered currently. The announcement can be done at periodic time based on timer configured by at least one of the 5GC, the AF, the PINNF, a PINMF or based on negotiation between the PINE and the PEMC (100)/PINNF/PINMF/PEGC (200) or it can be an implementation dependent timer.

In yet another embodiment, the PINE can register with the PEMC (100)/the PINNF/the PIN-AF to get to know when the service is added or removed in the PIN (1000). When the particular service is added or removed from the PIN (1000) then that PINE is notified about the respective action.

In an embodiment, the offered service is added or removed from the PIN (1000) if the respective PINE which offers the service has been added to the PIN (1000) or removed from the PIN (1000) respectively.

In yet another embodiment, the first PINE (300a) which offers the service can remain in the PIN (1000) i.e. it is not removed from the PIN (1000), but that particular PIN is barred to offer the particular service by the 5GC, the PINNF, the PINAF then took the service is not offered considered in the PIN though the first PINE (300a) continue to remain in the PIN. i.e. 5GC, the PINNF, the PINAF can indicate to the PEMC (100)/PEGC (200) that particular service(s) are barred i.e. those services is not be offered by the PIN (1000).

After the list of available services in the PIN is updated, the PINE/the PINNF/the PEMC (100) indicates/determines the mandatory services which it (for e.g. the PINE) needs, if those mandatory services are available, keep the PINE in the PIN (1000). When any/all of the mandatory services for PINE are released, the PINE also exits the PIN (1000) by initiating the PIN release procedure or the PEGC (200)/PEMC (100)/PINNF/PINAF/user removes the PINE from the PIN by executing the respective procedure.

Based on the received announcement of change in supported services as discussed in the embodiment, when the PINE determines that required services are not offered by the PIN then it can initiate the PIN release procedure to exit the PIN (1000).

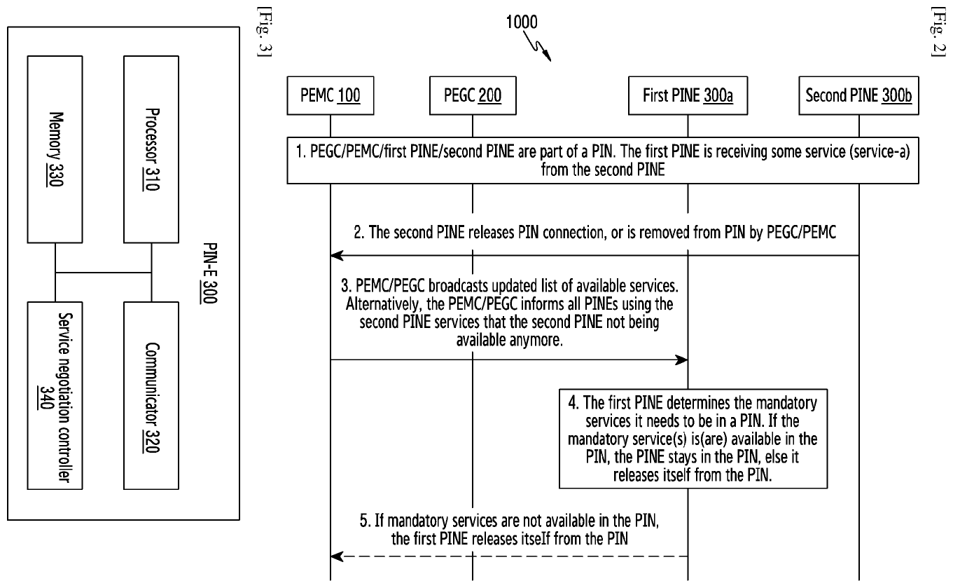

FIG. 3 shows various hardware components of the PINE (300), according to the embodiments as disclosed herein. In an embodiment, the PINE (300) includes a processor (310), a communicator (320), a memory (330) and a service negotiation controller (340). The processor (310) is coupled with the communicator (320), the memory (330) and the service negotiation controller (340).

The service negotiation controller (340) receives the service from the second PINE (300b) in the PIN (1000). The first PINE (300a) and the second PINE (300b) are registered with the PIN network apparatus (400) in the PIN (1000). The PIN network apparatus (400) can be, for example, but not limited to the PIN server, the PEGC (200), and the PEMC (100). Further, the service negotiation controller (340) receives the PIN profile from the PIN network apparatus (400). The PIN profile includes the list of PINE available in the PIN (1000) and service offered by the list of PINE available in the PIN (1000). In an example, Table 1 indicates the PIN profile in the PIN server, the PEMC (100), the PEGC (200) and the PINE (300).

TABLE 1

| Parameter | | PIN | | | |
|---|---|---|---|---|---|
| Name | Parameter Description | Server | PEMC | PEGC | PINE |
| PIN ID | The identifier of the PIN | Yes (Y) | Y | Y | Y |
| Duration | Specifies the time period of how | Y | Y | Y | Y |
| | long the PIN can be active | | | | |
| PIN service | List of service that a PIN can | Y | Y | N | Y |
| | provide, including the PINE service | | | | |
| | or the service that can provided by | | | | |
| | application client on PINE: | | | | |
| | > PIN service Provider Identifier | | | | |
| | > PIN service type | | | | |
| | > PIN service Feature | | | | |
| PIN | List of PIN elements which can be | Y | Y | Y | N |
| Elements | allowed to join the PIN | | | | |
| List | > PIN element ID | | | | |

Further, the service negotiation controller (340) determines whether the service from the second PINE (300b) is available in the PIN (1000) based on the list of PINE available in the PIN (1000) and the service offered by the list of PINE available in the PIN (1000). In an embodiment, the service negotiation controller (340) remains in the PIN (1000) and receives the service in the PIN (1000) when the service is available in the PIN (1000). In an embodiment, the service negotiation controller (340) leaves the PIN (1000) when the service or the second PINE (300b) is not available in the PIN (1000).

The service negotiation controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. The term “non-transitory” should not be interpreted that the memory (330) is non-movable. In certain examples, a non-transitory storage medium may store data that can, over time, change (e.g., in Random Access Memory (RAM) or cache).

Although the FIG. 3 shows various hardware components of the PINE (300) but it is to be understood that other embodiments are not limited thereon. In other embodiments, the PINE (300) may include less or more number of components. Further, the labels or names of the components are used only for illustrative purpose and does not limit the scope of the invention. One or more components can be combined together to perform same or substantially similar function in the PINE (300).

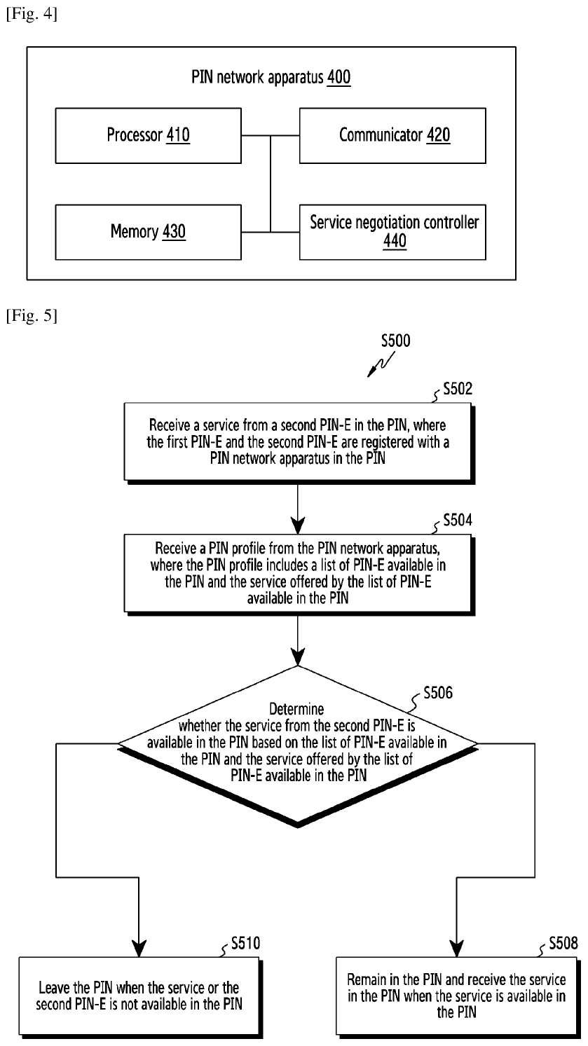

FIG. 4 shows various hardware components of the PIN network apparatus (400), according to the embodiments as disclosed herein. In an embodiment, the PIN network apparatus (400) includes a processor (410), a communicator (420), a memory (430) and a service negotiation controller (440). The processor (410) is coupled with the communicator (420), the memory (430) and the service negotiation controller (140).

The service negotiation controller (440) detects the event in the PIN (1000). The event can be, for example, but not limited to the new PINE joined the PIN (1000), the service offered by the newly joined PINE in the PIN (1000), the PINE removed by the PIN network apparatus (400) in the PIN (1000), the PINE leaving the PIN (1000), the change in capability of the PINE (300a) in the PIN (1000), and the change in the service of the PINE (300a) in the PIN (1000). Further, the service negotiation controller (440) updates the PIN profile including the list of PINE available in the PIN (1000) and the service offered by the list of PINE available in the PIN (1000) based on the detected event. Further, the service negotiation controller (440) sends the PIN profile to the PINE (300a) in the PIN (1000) by broadcasting the PIN profile to all PINE in the PIN (1000) or sending the PIN profile to the PINE (300a) that uses the service in the PIN (1000).

In an embodiment, the service negotiation controller (440) receives the request message to join the PIN (1000) from the PINE (300a). The request message includes the security credentials of the PINE (300a), a UE identifier, and the service offered by the PINE (300a). Further, the service negotiation controller (440) verifies whether the PINE (300a) is authorized to join the PIN (1000). Further, the service negotiation controller (440) joins the PINE (300a) to the PIN (1000) upon successful verification. Further, the service negotiation controller (440) updates the PIN profile with information of the PINE (300a) and the service offered by the newly joined PINE in the PIN (1000).

In an embodiment, the service negotiation controller (440) receives a request message to leave the PIN from the PINE (300a). The request message includes the security credentials of the PINE (300a), a UE identifier, and the service offered by the PINE (300a). Further, the service negotiation controller (440) verifies whether the PINE (300a) is authorized. Further, the service negotiation controller (440) removes the PINE (300a) from the PIN (1000) and disables access of the PINE (300a) to a 5GS in the PIN (1000) based on the request. Further, the service negotiation controller (440) updates the PIN profile with information of the PINE (300a) that requested to leave the PIN (1000).

In an embodiment, the service negotiation controller (440) determines to remove the PINE (300a) from the PIN (1000). Further, the service negotiation controller (440) sends a notification about removal to the PINE (300a). Further, the service negotiation controller (440) removes the PINE (300a) from the PIN (1000) and disables access of the PINE (300a) to the 5GS in the PIN (1000). Further, the service negotiation controller (440) updates the PIN profile with information of the PINE (300a) removed from the PIN (1000).

The service negotiation controller (440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. The term “non-transitory” should not be interpreted that the memory (430) is non-movable. In certain examples, a non-transitory storage medium may store data that can, over time, change (e.g., in Random Access Memory (RAM) or cache).

Although the FIG. 4 shows various hardware components of the PIN network apparatus (400) but it is to be understood that other embodiments are not limited thereon. In other embodiments, the PIN network apparatus (400) may include less or more number of components. Further, the labels or names of the components are used only for illustrative purpose and does not limit the scope of the invention. One or more components can be combined together to perform same or substantially similar function in the PIN network apparatus (400).

FIG. 5 is a flow chart (S500) illustrating a method, implemented by the PINE (300), for service negotiation in the PIN (1000), according to the embodiments as disclosed herein. The operations (S502-S510) are handled by the service negotiation controller (340).

At step S502, the method includes receiving the service from the second PINE (300b) in the PIN (1000). The first PINE (300a) and the second PINE (300b) are registered with the PIN network apparatus (400) in the PIN (1000). At step S504, the method includes receiving the PIN profile from the PIN network apparatus (400). The PIN profile includes the list of PINE available in the PIN (1000) and the service offered by the list of PINE available in the PIN (1000). At step S506, the method includes determining whether the service from the second PINE (300b) is available in the PIN (1000) based on the list of PINE available in the PIN (1000) and the service offered by the list of PINE available in the PIN (1000). At step S508, the method includes remaining in the PIN (1000) and receiving the service in the PIN (1000) when the service is available in the PIN (1000). At step S510, the method includes leaving the PIN (1000) when the service or the second PINE (300b) is not available in the PIN (1000).

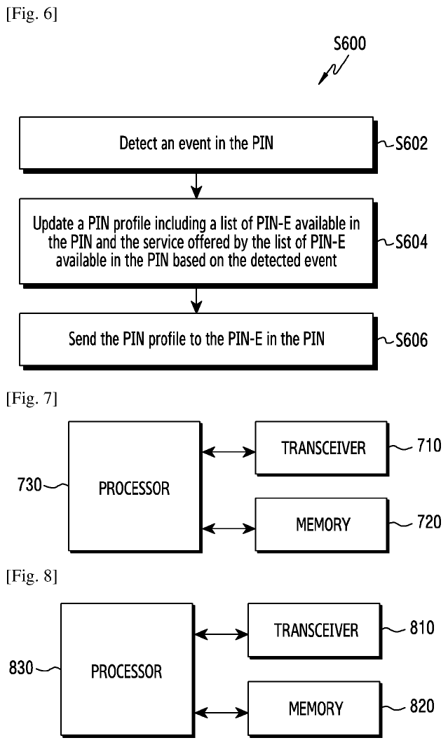

FIG. 6 is a flow chart (S600) illustrating a method, implemented by the PIN network apparatus (400), for the service negotiation in the PIN (1000), according to the embodiments as disclosed herein. The operations (S602-S606) are handled by the service negotiation controller (440).

At step S602, the method includes detecting the event in the PIN. At step S604, the method includes updating the PIN profile including the list of PINE available in the PIN and the service offered by the list of PINE available in the PIN based on the detected event. At step S606, the method includes sending the PIN profile to the PINE in the PIN (1000).

FIG. 7 illustrates a block diagram of a terminal (or a user equipment (UE)), according to embodiments of the present disclosure.

As shown in FIG. 7, a terminal according to an embodiment may include a transceiver 710, a memory 720, and a processor (or a controller) 730. The transceiver 710, the memory 720, and the processor (or controller) 730 of the terminal may operate according to a communication method of the terminal described above. However, the components of the terminal are not limited thereto. For example, the terminal may include more or fewer components than those described in FIG. 7. In addition, the processor (or controller) 730, the transceiver 710, and the memory 720 may be implemented as a single chip. Also, the processor (or controller) 730 may include at least one processor.

The transceiver 710 collectively refers to a terminal station receiver and a terminal transmitter, and may transmit/receive a signal to/from a base station or another terminal. The signal transmitted or received to or from the terminal may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor (or controller) 730, a signal through a wireless channel, and transmit a signal output from the processor (or controller) 730 through the wireless channel.

The memory 720 may store a program and data required for operations of the terminal. Also, the memory 720 may store control information or data included in a signal obtained by the terminal. The memory 720 may be a storage medium, such as read-only memory (ROM), random access memory (RAM), a hard disk, a CD-ROM, and a DVD, or a combination of storage media.

The processor (or controller) 730 may control a series of processes such that the terminal operates as described above. For example, the processor (or controller) 730 may receive a data signal and/or a control signal, and the processor (or controller) 730 may determine a result of receiving the signal transmitted by the base station and/or the other terminal.

The terminal (or UE) according to FIG. 7 may refer to at least one of the PEGC (200), the PEMC (100), the first PINE (300a), the second PINE (300b), the PINMF, the PINNF, the PINAF, the PIN server, or the PIN network apparatus described above.

FIG. 8 illustrates a block diagram of a base station, according to embodiments of the present disclosure.

As shown in FIG. 8 is, the base station of the present disclosure may include a transceiver 810, a memory 820, and a processor (or, a controller) 830. The transceiver 810, the memory 820, and the processor (or controller) 830 of the base station may operate according to a communication method of the base station described above. However, the components of the base station are not limited thereto. For example, the base station may include more or fewer components than those described in FIG. 8. In addition, the processor (or controller) 1330, the transceiver 810, and the memory 820 may be implemented as a single chip. Also, the processor (or controller) 1330 may include at least one processor.

The transceiver 810 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor (or controller) 830, a signal through a wireless channel, and transmit a signal output from the processor (or controller) 830 through the wireless channel.

The memory 820 may store a program and data required for operations of the base station. Also, the memory 820 may store control information or data included in a signal obtained by the base station. The memory 820 may be a storage medium, such as ROM, RAM, a hard disk, a CD-ROM, and a DVD, or a combination of storage media.

The processor (or controller) 830 may control a series of processes such that the base station operates as described above. For example, the processor (or controller) 830 may receive a data signal and/or a control signal, and the processor (or controller) 830 may determine a result of receiving the signal transmitted by the terminal and/or the core network function.

The base station according to FIG. 8 may refer to at least one of the PEGC (200), the PEMC (100), the first PINE (300a), the second PINE (300b), the PINMF, the PINNF, the PINAF, the PIN server, or the PIN network apparatus described above.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various actions, acts, blocks, steps, or the like in the flow charts (S500 and S600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a personal internet of things (IoT) network (PIN) element with management capability (PEMC) entity (100) in a wireless communication system, the method comprising:
transmitting, to at least one personal internet of things (IoT) network element (PINE) entity subscribing for a PIN status notification, information on at least one service that a first PINE entity provides, based on a first message for joining a PIN (1000); and
updating a list of services that are offered within the PIN based on the information on the at least one service,
wherein the first message includes the information on the at least one service, and
wherein the at least one PINE entity includes a PIN element with gateway capability (PEGC) entity.

17. The method of claim 16, further comprising:
transmitting, to the at least one PINE entity subscribing for the PIN status notification, information on a third PINE entity which is removed from the PIN; and
updating a list of services that are offered within the PIN based on the information on the third PINE entity.

18. The method of claim 17, further comprising:
receiving, from a second PINE entity, a second message for leaving the PIN based on the PIN status notification.

19. The method of claim 16, further comprising:
adding the first PINE entity to the PIN.

20. The method of claim 16, further comprising:
receiving, from a second PINE entity, a third message for subscribing with the PEMC entity for the PIN status notification.

21. A method performed by a second PINE entity in a wireless communication system, the method comprising:
receiving, from a PEMC entity that the second PINE entity subscribed with for a PIN status notification, information on at least one service related to a first PINE entity, based on a first message for joining a PIN (1000); and
updating a list of services that are offered within the PIN based on the information on the at least one service,
wherein the first message includes the information on the at least one service.

22. The method of claim 21, further comprising:
receiving, from the PEMC entity, the information on a third PINE entity which is removed from the PIN; and
updating a list of services that are offered within the PIN based on the information on the third PINE entity.

23. The method of claim 22, further comprising:
transmitting, to the PEMC entity, a second message for leaving the PIN based on the PIN status notification.

24. The method of claim 21, wherein the first PINE entity is added to the PIN.

25. The method of claim 21, further comprising:
transmitting, to the PEMC entity, a third message for subscribing with the PEMC entity for the PIN status notification.

26. A PEMC entity (100) in a wireless communication system, the PEMC entity comprising:
a transceiver; and
a controller coupled with the transceiver and configured to:
transmit, to at least one personal internet of things (IoT) network element (PINE) entity subscribing for a PIN status notification, information on at least one service that a first PINE entity provides, based on a first message for joining a PIN (1000), and
update a list of services that are offered within the PIN based on the information on the at least one service,
wherein the first message includes the information on the at least one service, and
wherein the at least one PINE entity includes a PIN element with gateway capability (PEGC) entity.

27. The PEMC entity of claim 26, wherein the controller is further configured to:
transmit, to the at least one PINE entity subscribing for the PIN status notification, information on a third PINE entity which is removed from the PIN, and
update a list of services that are offered within the PIN based on the information on the third PINE entity.

28. The PEMC entity of claim 27, wherein the controller is further configured to receive, from a second PINE entity, a second message for leaving the PIN based on the PIN status notification.

29. The PEMC entity of claim 26, wherein the controller is further configured to add the first PINE entity to the PIN.

30. The PEMC entity of claim 26, wherein the controller is further configured to receive from a second PINE entity, a third message for subscribing with the PEMC entity for the PIN status notification.

31. A second PINE entity in a wireless communication system, the second PINE entity comprising:
a transceiver; and
a controller coupled with the transceiver and configured to:
receive, from a PEMC entity that the second PINE entity subscribed with for a PIN status notification, information on at least one service related to a first PINE entity, based on a first message for joining a PIN (1000), and
update a list of services that are offered within the PIN based on the information on the at least one service,
wherein the first message includes the information on the at least one service.

32. The second PINE entity of claim 31, wherein the controller is further configured to:
receive, from the PEMC entity, the information on a third PINE entity which is removed from the PIN, and
update a list of services that are offered within the PIN based on the information on the third PINE entity.

33. The second PINE entity of claim 32, wherein the controller is further configured to transmit, to the PEMC entity, a second message for leaving the PIN based on the PIN status notification.

34. The second PINE entity of claim 31, wherein the first PINE entity is added to the PIN.

35. The second PINE entity of claim 31, wherein the controller is further configured to transmit, to the PEMC entity, a third message for subscribing with the PEMC entity for the PIN status notification.
